(19) United States
(12) Patent Application Publication
(10) Pub. No.: US 2016/0026353 A1
(43) Pub. Date: Jan. 28, 2016

(54) IMPLEMENTING MANAGEMENT OF ASSOCIATIONS BETWEEN ORGANIZATION STRUCTURE ELEMENTS

(71) Applicants: Eleftherios Ntouanoglou, Thessaloniki (GR); Brandon L. Hudgeons, Austin, TX (US)

(72) Inventors: Eleftherios Ntouanoglou, Thessaloniki (GR); Brandon L. Hudgeons, Austin, TX (US)

(73) Assignee: SCHOOX INC., AUSTIN, TX (US)

(21) Appl. No.: 14/340,545

(22) Filed: Jul. 24, 2014

(51) Int. Cl. G06F 3/0484; G06F 3/0481; G06Q 10/06; G06F 17/30

(52) U.S. Cl. CPC G06F 3/0484; G06F 17/30864; G06F 3/04817; G06Q 10/067

(57) ABSTRACT

An information management solution is disclosed that overcomes drawbacks associated with the ability of traditional hierarchy structures to support complex organizational structures. The information management solution uniquely implements a two-level entity associating map for depicting relationships between entities of a group of entities. A first level of the two-level entity association map has units is a one-dimensional layer comprising organizational entities and a second level of the two-level entity associating map is a multi-dimensional level comprising organizational entities to which organizational entities of the first level have a direct association. An entity type of any first-level entity is different than an entity type of any second-level entity.

### FIELD OF THE DISCLOSURE

The disclosures made herein relate generally to managing information between entities and, more particularly, to implementing management of information defining associations between organization structure elements.

### BACKGROUND

It is well known that accommodating a complex organizational structure in traditional software applications is a challenge that has been met with limited success. A franchise organization, an educational organization and a social media community are examples of such a complex organizational structure. A primary reason for this limited success relates to the configuration of organizational structures that these traditional software applications are intended to accommodate. For example, franchise organizations' stores are independent units that typically need to be associated with different independent organizations that have competing organizational (e.g., hierarchy) positioning, which can lead to overlap of administrative rights.

Some traditional software applications are intended for supporting top down, pyramid-style hierarchies. Other traditional software applications are intended for supporting two-dimensional matrix-style hierarchies in which one business unit can be connected to two different nodes. One characteristic of these types of organizational structures is that user permissions given at any level are usually inherited by all levels below. In these respects, these two types of traditional hierarchy structures (i.e., top down, pyramid-style hierarchy and two-dimensional matrix-style hierarchy) can accommodate hierarchies found in traditional types of organizational structures.

Complex organizational structures generally do not have a top down, pyramid-style hierarchy or a matrix-style hierarchy. In contrast, for example, a franchise organization that consists of stores, which will often have a mixture of corporate and franchisee stores, has special needs that neither a pyramid-style hierarchy nor a two-dimensional matrix hierarchy can support. A franchise organization has a need for franchise instances (e.g., stores) to be connected to many different and often independent organizational nodes. This can make a typical set of user permissions of various software applications (e.g. learning management, content management, collaboration and communication systems) very difficult and sometimes impossible to implement. For example, a franchise instance within the restaurant, hospitality or retail industry may need to be connected at the same time to a franchisee agreement, a multi-unit owner office, a region or territory, a country or language and, if the entity has more than one concept, even a brand.

Traditional hierarchy structures have certain inherent limitations that limit their effectiveness with respect to complex organizational structures such as franchise organizations, educational organizations and social media communities. The pyramid-style hierarchy is limited in its ability to accommodate multiple types of different organization nodes that are at the same level, which is the case with many franchisee organizations. Also, because of the multiple levels, the design of the user interface and user experience of software applications supporting a pyramid-style hierarchy becomes cumbersome when the number of levels increases. The two-dimensional matrix-style hierarchy has the limitation that a business unit (e.g., a store) can only be connected to two adjacent-level nodes (e.g., subtending nodes in a hierarchy). Although this may be suitable for relatively simple organizational structures, this is a considerable limitation for a complex organizational structure. Therefore, an information management solution (e.g., implemented as a software application) that overcomes drawbacks associated with the ability of traditional hierarchy structures to support complex organizational structures would be beneficial, desirable and useful.

### SUMMARY OF THE DISCLOSURE

Embodiments of the present invention are directed to an information management solution that overcomes drawbacks associated with the ability of traditional hierarchy structures to support complex organizational structures. To this end, an information management solution configured in accordance with an embodiment of the present invention uniquely implements a two-level organization structure chart (i.e. an entity associating map) for depicting relationships between entities of a group of entities (i.e., a business organization, an educational organization, a team of individuals, a social media community, or the like). A first level of the two-level organization structure chart is a one-dimensional layer comprising organizational entities (i.e., nodes such as, for example, a store, business unit, or the like, in the case of a franchise) and a second level of the two-level organization structure chart is a multi-dimensional level comprising organizational entities (i.e., nodes such as a region, a concept or brand, a franchisee agreement, a country, a franchise agent, and/or the like, in the case of a franchise) to which organizational entities of the first level have a direct association. An entity type of any first-level entity is different than an entity type of any second-level entity. In at least one embodiment, an organization element relationship management method comprises such functionality.

An information management solution configured in accordance with an embodiment of the present invention has utility in a variety of applications and commercial enterprises. Online learning, content management, collaboration and communication are examples of such applications. Restaurants, hospitality service organizations, retail business organizations, and social media communities (e.g., an organization in the context of the disclosures made herein) are examples of such business endeavors. It is well known that these types of business endeavors struggle tremendously with the limitations of information management solutions that are not well-suited for complex organizational structures.

In one embodiment of the present invention, a method comprising receiving information defining a plurality of first-level entities, receiving information defining a plurality of second-level entities, receiving information defining associations between the first and second level entities, and creating a visual depiction of the entities and the association therebetween. Each one of the first-level entities defines a respective entity within a group of associated entities. Each one of the second-level entities defines a respective entity within the group of associated entities. The associations indicate that each one of the first-level entities is directly associated with only one or more of the second-level entities and that each one of the second-level entities is directly associated with only one or more of the first-level entities. The associations between the first-level and second-level entities are depicted for indicating that each one of the first-level entities is directly associated with only one or more of the second-level entities and that each one of the second-level entities is directly associated with only one or more of the first-level entities.

In another embodiment of the present invention, a non-transitory computer-readable storage medium having tangibly embodied thereon and accessible therefrom instructions interpretable by at least one data processing device. The instructions are configured for causing the at least one data processing device to perform a method enabling a user to create an organization structure chart for depicting relationships between entities of an organization. The method comprising specifying a plurality of organizational elements that are all affiliated with the organization, assigning a first plurality of the organizational elements to a first level of an organization structure chart characterizing relationships between the organizational elements, assigning a second plurality of the organizational elements to a second level of the organization structure chart, and indicating relationships between the organizational elements of the first level of the organization structure chart and the organizational elements of the second level of the organization structure chart. Indicating the relationships is limited to indicating that each one of the organizational elements of a particular one of the levels is associated with one or more of the organizational elements of the other one of the levels.

In another embodiment of the present invention, a non-transitory computer-readable storage medium having tangibly embodied thereon and accessible therefrom instructions interpretable by at least one data processing device. The instructions are configured for causing the at least one data processing device to perform a method enabling a user to create a two-level organization structure chart that depicts associations between a plurality of entities. The method comprises instantiating a plurality of first-level entities each defining a respective entity from a collection of entities, instantiating a plurality of second-level entities each defining a respective entity from the collection of entities, and defining associations between the first-level and second-level entities in a manner such that each one of the first-level entities is directly associated with only one or more of the second-level entities and such that each one of the second-level entities is directly associated with only one or more of the first-level entities.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a block diagram showing an organization structure chart 100 configured in accordance with an embodiment of the present invention.

FIG. 2 is a diagrammatic view showing an organization structure chart type selection portion of a system configured in accordance with an embodiment of the present invention.

FIG. 3 is a diagrammatic view showing an Above Unit entry (i.e., second-level entity entry) set-up portion of a system configured in accordance with an embodiment of the present invention.

FIG. 4 is a diagrammatic view showing a permissions set-up portion of a system configured in accordance with an embodiment of the present invention.

FIG. 5 is a diagrammatic view showing a Unit entry (i.e., first-level entity entry) set-up portion of a system configured in accordance with an embodiment of the present invention.

FIG. 6 is a diagrammatic view showing a permission assignment set-up portion of a system configured in accordance with an embodiment of the present invention.

FIG. 7 is a diagrammatic view showing a non-managerial job set-up portion of a system configured in accordance with an embodiment of the present invention.

FIG. 8 is a diagrammatic view showing use of the Above Unit entry (i.e., second-level entity entry) set-up portion of the system of FIG. 3 being used for setting-up non-managerial jobs.

FIG. 9 is a diagrammatic view showing a training platform portion of a system configured in accordance with an embodiment of the present invention.

### DETAILED DESCRIPTION

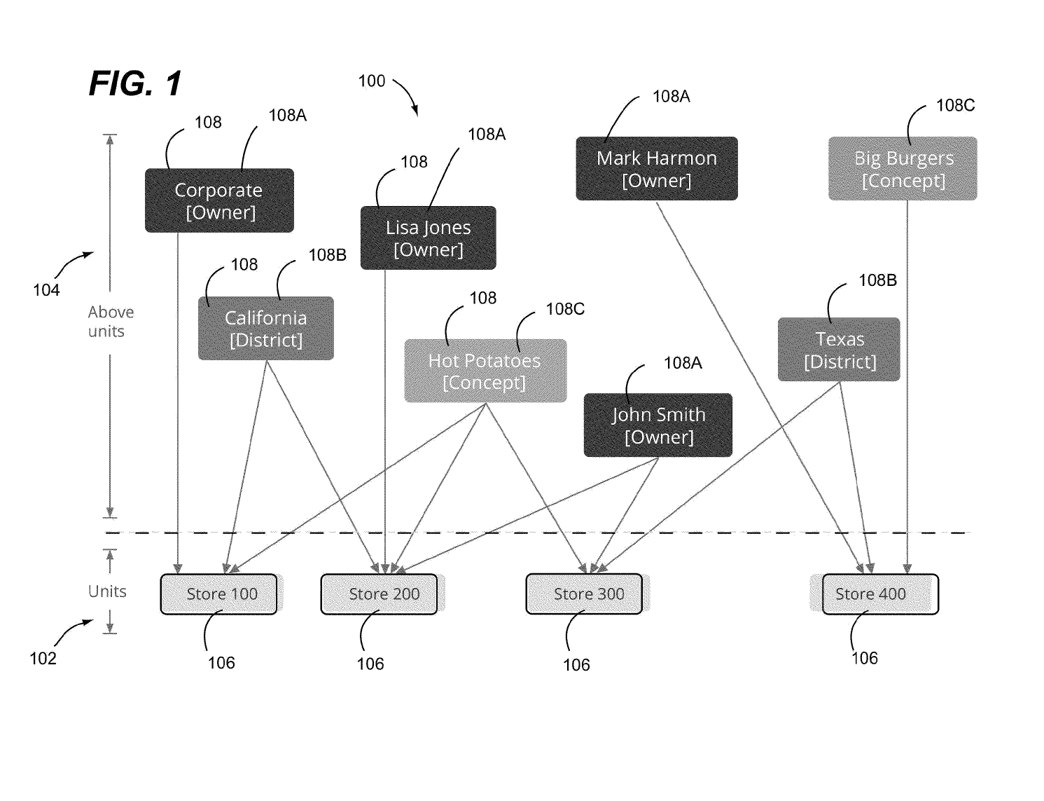

FIG. 1 shows an organization structure chart 100 configured in accordance with an embodiment of the present invention. In view of the disclosure made herein, a skilled person will appreciate that the organization structure chart 100 overcomes drawbacks associated with the ability of traditional hierarchy structures to support complex organizational structures. Examples of such complex organizational structures in the context of the present invention include, but are not limited to, a franchise organization, a business organization, an educational organization, a team of individuals, a social media community, and the like.

The organization structure chart 100 uniquely uses two levels (i.e., a two-level organization structure chart) for depicting relationships between entities (i.e., organizational elements) of a group of entities (e.g., a franchise, a social media community, etc). A first level 102 of the organization structure chart 100 is a one-dimensional layer and a second level 104 of the organization structure chart 100 is a multi-dimensional level. The first level 102 has a plurality of first-level entities 106 therein and the second level 104 has a plurality of second-level entities 108 therein. A respective icon represents each one of the first and second level entities. In view of the orientation of the levels of the organization structure chart 100, the first-level entities 106 can be referred to as units (i.e., units of the organization) and the second-level entities 108 can be referred to as above units. Each one of the first-level entities 106 is of an entity type (i.e., stores) that is the same as each other one of the first-level entities 106. In contrast, several of the second-level entities 108 are of an entity type different than other ones of the second-level entities 108 (e.g., owner of a store, district in which a store is located, a concept (e.g., brand) of a store). As can be seen, the entity type of any one of the first-level entities 106 is different than the entity type of any one of the second-level entities 108. Accordingly, in the context of the disclosures made herein, a one-dimensional layer refers to a layer in which all of the entities have a common role or type and a multi-dimensional level refers to a layer in which entities are not limited to having a common role and/or type.

In an organization structure chart configured in accordance with the present invention (e.g., the organization structure chart 100), each one of the first-level entities 106 (i.e., units) can be connected to (i.e., associated with) as many second-level entities 108 (i.e., above units) as is necessary to suitably depict corresponding relationships between entities of a collection of entities (e.g., an organization). Furthermore, there is no limit to the number of second-level entities 108 that can be connected to a particular one of the first-level entities 106. For example, in the case of a franchisee organization that is being depicted by an organization structure chart configured in accordance with the present invention, a store that is owned by two franchisees can be connected to both of its owners (e.g., as shown in FIG. 1 with John Smith and Lisa Edwards being owners of Store 200). Furthermore, it is disclosed herein that an organization structure chart configured in accordance with the present inventions can be displayed in a plurality of different views that each depict a respective subset of relationships within an organization (e.g., production organizational element relationships and sales organizational element relationships, social media group A organizational elements relationships and social media group B organizational elements relationships).

As will be discussed below in greater detail, each of the first-level entities 106 or second-level entities 108 can have one or more users which can be given different roles or jobs and, correspondingly, can be given different permissions and rights. Permissions and rights for various administrative features (e.g. managing users, accessing reporting data, assigning courses etc) can be given to different entities at the unit or above unit level, which will be able to use these administrative features only for their area of authorization. For example, with respect to a franchise organization such as that discussed above in reference to FIG. 1, user permissions and rights for second-level entities could be implemented as follows. A ‘Unit Manager’ could be the general manager of a store and be given the permissions, for example, to edit users (e.g. add/remove users, edit jobs), get reports about training performance, creating and assigning courses but only for employees of his or her store. An ‘Above Unit Manager’ (e.g. Region Manager or Franchisee Manager) could be given similar permissions as the Unit Manager, but only to be applied to employees that are connected either to the appropriate above unit office (e.g. Region=California) or to the stores that are connected to the Above Unit (e.g. stores that belong to California or to a Franchisee). In this respect, user permissions for various functions are implemented in a manner that is flexible and that can be set up independently at the unit level (i.e., first-level entity) and above unit level (i.e., second-level entity).

Presented now is a discussion on implementing a method configured in accordance with the present invention for creating an organization structure chart. In particular, the method will be discussed in reference to creating the organization structure chart 100 discussed above in reference to FIG. 1. However, embodiments of the present invention are not unnecessarily limited to any particular organization or organizational structure.

The organization structure chart 100 is for a franchise organization (i.e., business) referred to herein as “Hot Potatoes”. Hot Potatoes is a chain of restaurants with corporate and franchise stores. The company has many stores in several countries. As shown, the franchise structure includes entities of different types, which include: ownership, district agent, and concept. Ownership entities 108a are a type of entity that represent full or partial owners of one or more stores of the franchise organization (i.e., one of the first level entities 106). District agent entities 108b are a type of entity that represents a relative location (e.g., certain region in a country) in which an associated store of the franchise organization is located. Concept entities 108c are a type of entity that represents a store concept (e.g., brand, trade dress, etc) for the various stores of the franchise organization.

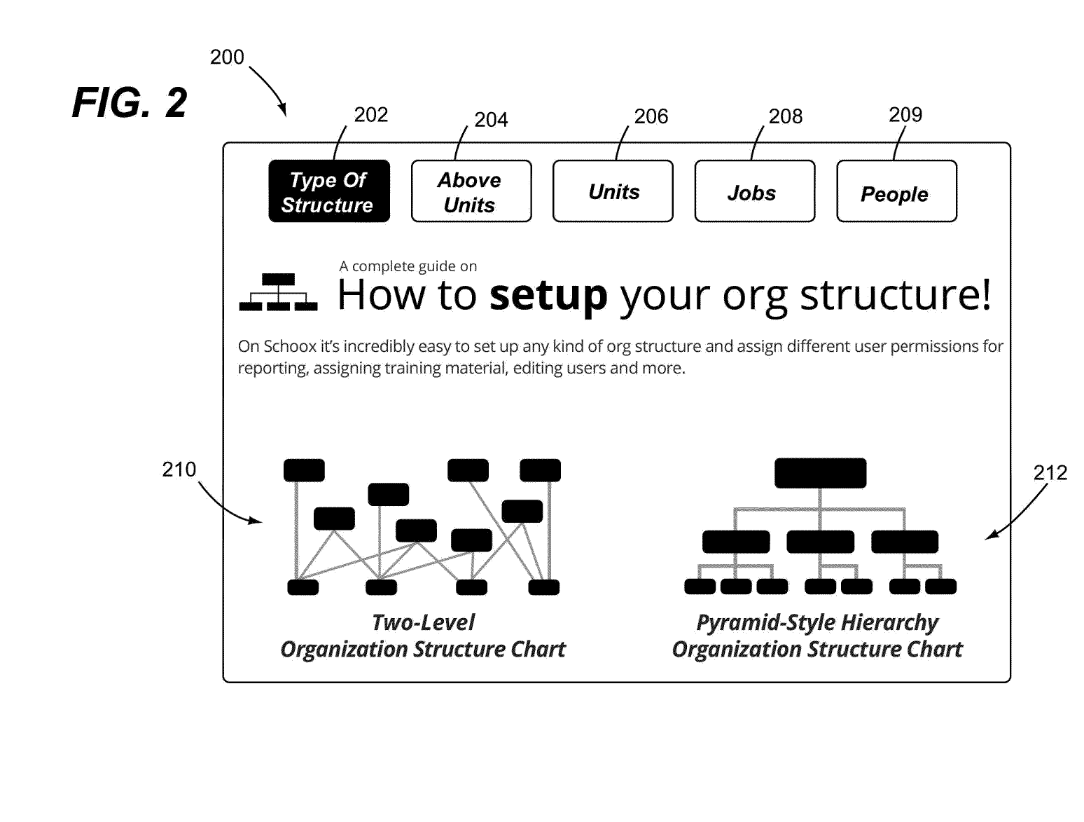

Referring to FIGS. 2-10, a user interface 200 of a system configured in accordance with an embodiment of the present invention (e.g., computer implementing an organization element relationship management method (e.g., via software)) has a plurality of tabs 202-209. Referring to FIG. 2, a first tab 202 is provided for enabling a user to select a type of organizational structure chart. A user can choose between a first chart type selection 210 for being guided through creation of a two-level organization structure chart as taught herein or a second chart type selection 212 for a traditional pyramid-style hierarchical organization structure chart. The traditional pyramid-style hierarchical organization structure chart is not specifically relevant to embodiments of the present invention and, thus, will not be discussed further.

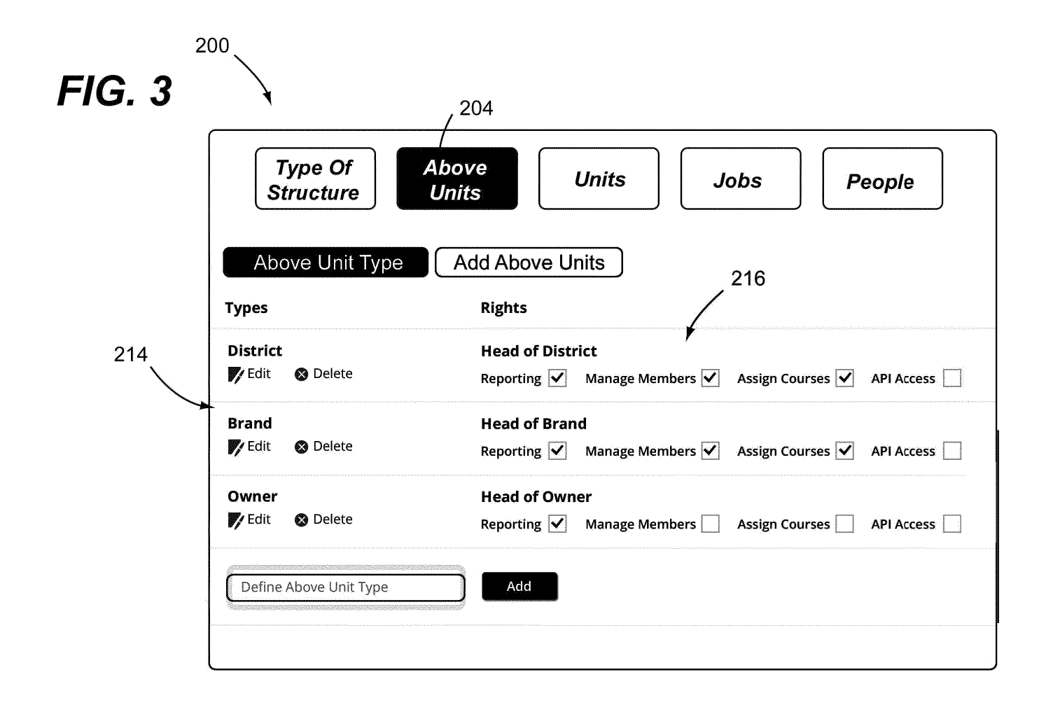

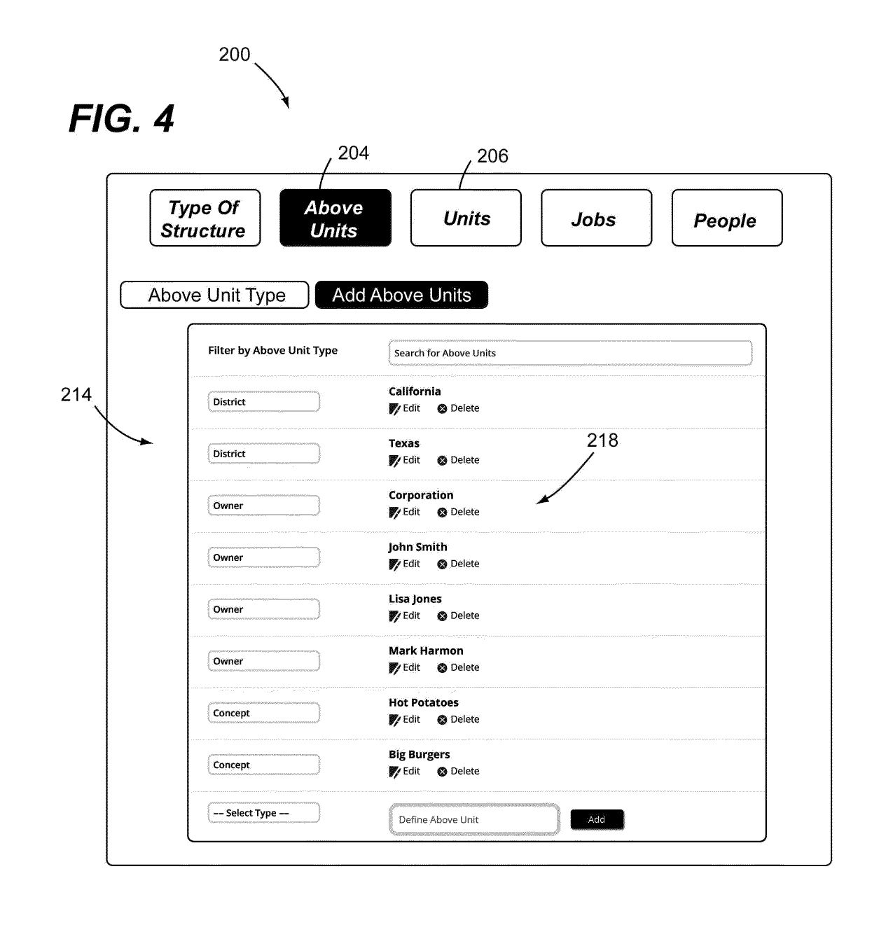

A second tab 204 of the user interface 200 (FIGS. 3 and 4) is provided for enabling a user to set-up Above Units (i.e., second-level entities) for a two-level organization structure chart. First, the user sets up Above Unit types 214 (FIG. 3), then the user sets up Above Unit permissions 216 for manager roles that the system will automatically create for each one of the Above Unit types 214 (FIG. 3), and finally the user sets up Above Unit entries 218 (FIG. 4). Furthermore, in certain embodiments, users that are given a management job at an Above Unit can use their administrative rights only over employees that are located either at the particular Above Unit or at any Unit that is connected to this Above Unit.

Still referring to FIGS. 3 and 4, the Above Unit types 214 each define a corresponding association (i.e., type of relationship) that an Above Unit can have with a connected Unit. In the depicted example, the Above Unit types 214 include, but are not limited to, District, Concept, and Owner. As can be seen, the system preferably, but not necessarily, automatically creates a management job for every Above Unit type 214 (i.e., “Head of {type of Above Unit}”. The Above Unit permissions 216 each define permissions and privileges for manager roles that the system will automatically create for each one of the Above Unit types 214. With a reporting permission, a user will have the permission to access the reporting dashboard but will be limited to see only Units and Above Units that under his or her authorization. With a manage members permission, a user will have the permission to edit users (e.g. adding new users, removing users, editing jobs, adding units etc), keeping in mind that the manager will be limited to edit users only of Above Units and Units that are under their authorization. With assign courses permission, a user will have the permission to assign courses (e.g., via a learning module of the system (e.g., portion of the software application thereof)) to employees that are in the Above Units or Units that are under their authorization. With an API access permission, a user will be given the authority to integrate with a learning module of the system, but only with the part of the learning module (i.e., related Above Units and Units) that are under their authorization.

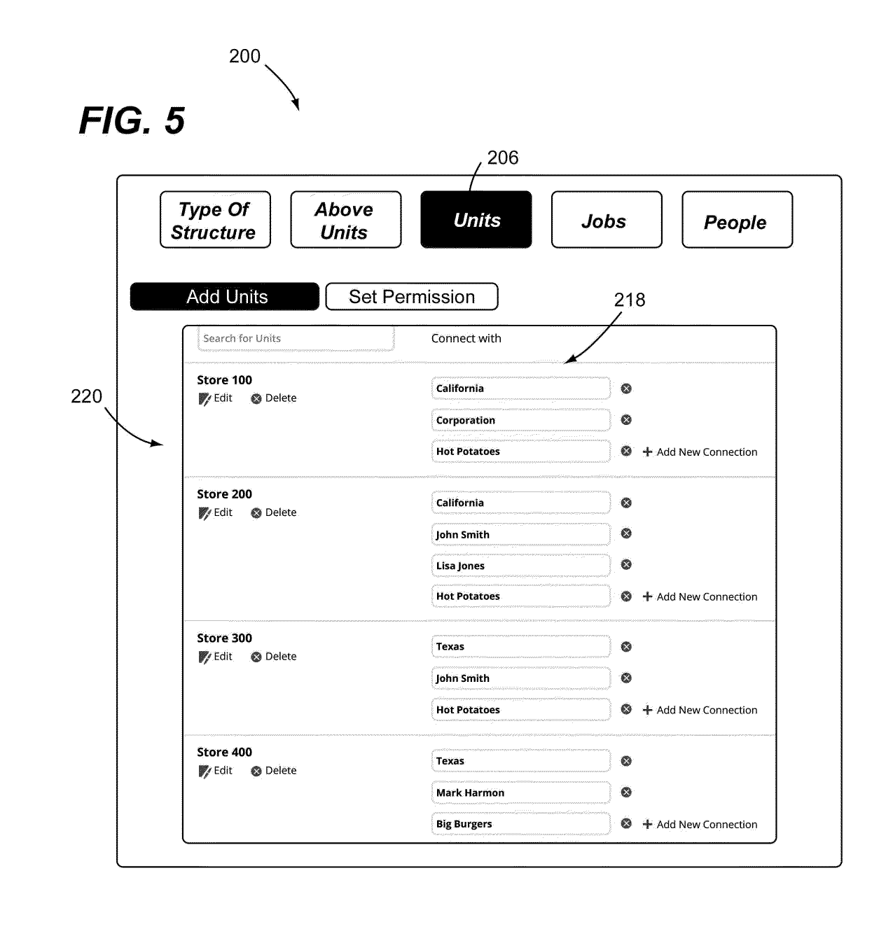

As shown in FIG. 5 at a third tab 206 of the user interface 200, after the user sets up Above Unit entries 218 as discussed above in reference to FIG. 4, the user then sets up Unit entries 220. For each one of the Unit entries 220, the user specified a name of the Unit for each of the Unit entries 220 and associates one or more of the previously set-up Above Unit entries 218 therewith. This association defines a relationship (i.e., connection) between each one of the Unit entries 220 (i.e., instantiation of a Unit) and the respective associated Above Unit entries 218 (i.e., instantiation of an Above Unit).

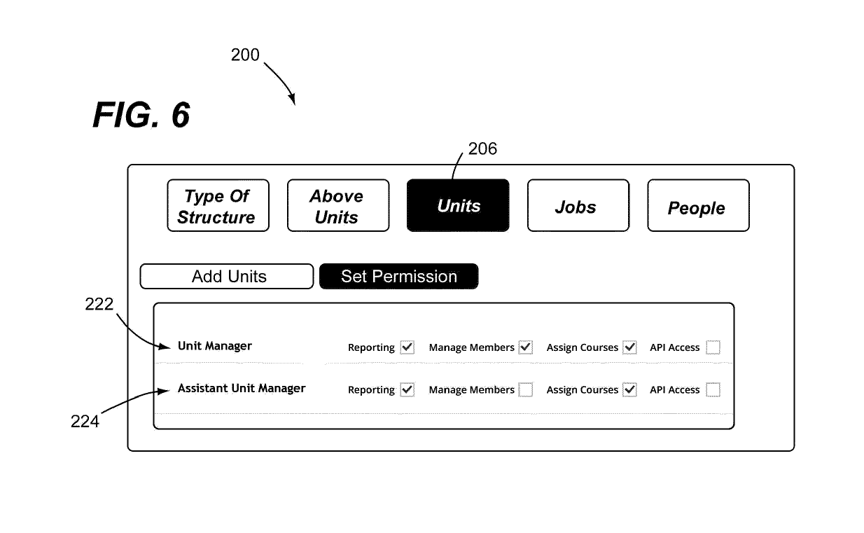

Referring now to FIG. 6, after the Unit entries 220 are set-up, the user can then assign permissions (i.e., administrative rights) for various managerial positions of a Unit. For example, Unit Manager 222 (e.g., General Manager of a store) and Assistant Unit Manager 224 (e.g., Assistance General Manager of a store) can be standard jobs in the system that come with configurable administrative rights are created automatically and that cannot be edited. To this end, the user can separately set administrative rights for the Unit Manager 222 and the Assistance Unit Manager 224. As disclosed above, examples of the permissions include, but are not limited to, reporting permission, manage members permission, assign courses permission, and API access permission.

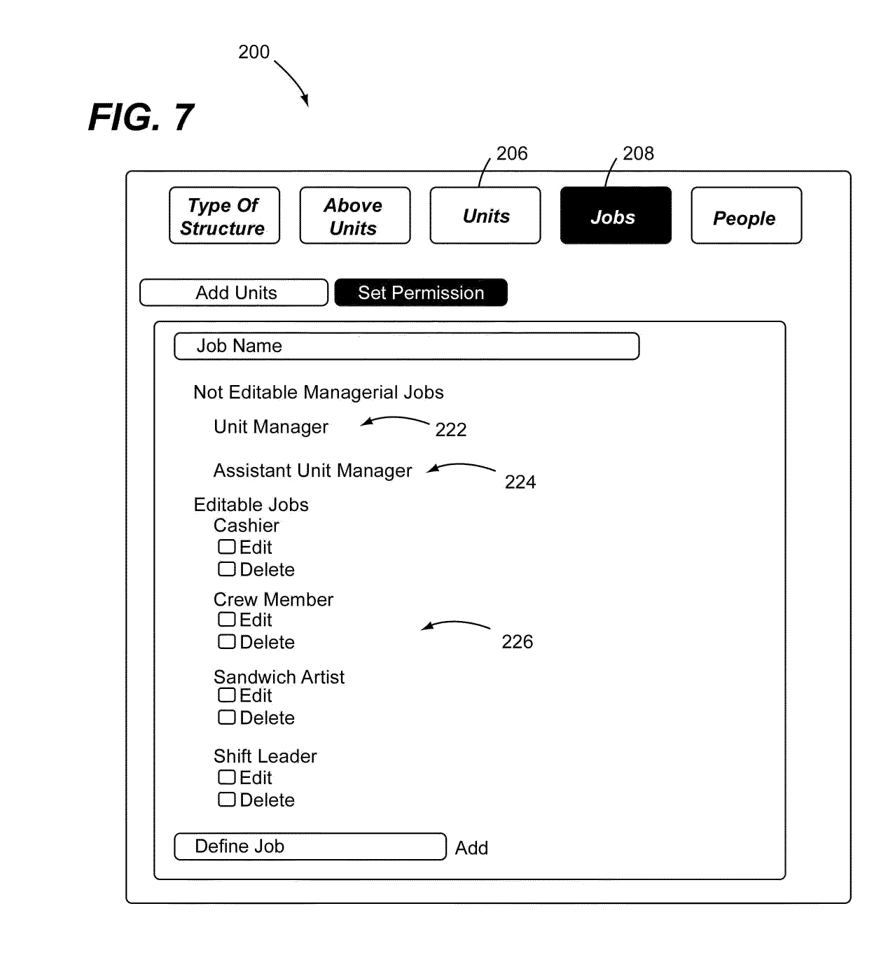

As shown in FIG. 7 at a fourth tab 208 of the user interface 200, besides management jobs (e.g., Unit Manager 222 and Assistant Unit Manager 224) a user can create as many non-managerial job entries 226 as necessary. In the depicted embodiment, examples of such non-managerial job entries 226 include, but are not limited to, a job entry “Cashier”, a job entry “Crew Member”, a job entry “Sandwich Artist”, and a job entry “Shift Leader”. Once created jobs can be assigned to employees who can be assigned to units or above units.

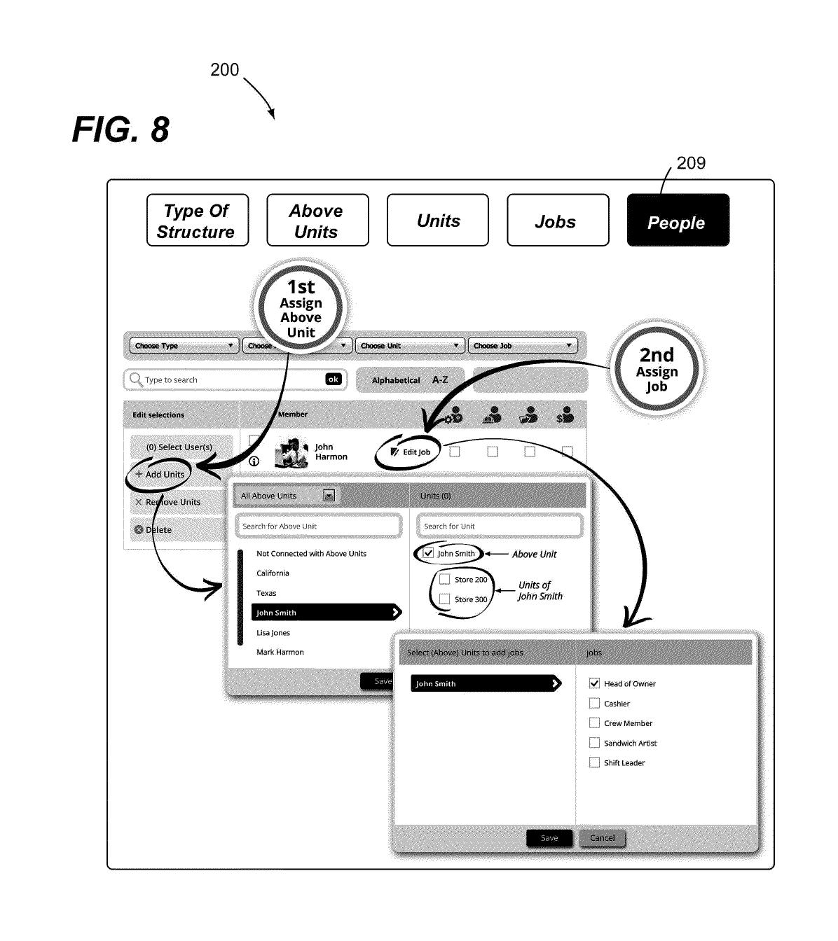

The preceding steps have been performed for defining an organization structure (i.e., the organization structure for the franchise organization referred to herein as Hot Potatoes). As shown in reference to a fifth tab 209 of the user interface 200 in FIG. 8, to complete the two-level organization entity chart, the users can define people involved in the organization and associate them with a corresponding job of one or more Units and/or Above Units. Jobs are assigned to people in combination with the Units and Above Units to which these people are connected. This means that a person can have different jobs for different Units and Above Units.

A person can be added to one or more Units or Above Units and be assigned to one or more jobs for every Unit or Above Unit to which they have been added. This results in their being connected to these corresponding Units or Above Units as defined by the previously set up organizational structure (e.g., as provided for in reference to FIGS. 2-7). People can be added to previously defined managerial jobs and non-managerial jobs.

Following are examples of people and their associated associations/assignments for managerial jobs, in an embodiment of a nomenclature depicting same:
John Smith [Franchisee] (Above Unit 1 (type: owner): John Smith, Job at Above Unit 1: Head of Owner Office);
Lisa Jones [Franchisee] (Above Unit 2 (type: owner): Lisa Jones, Job at Above Unit 2: Head of Owner Office);
Mark Harmon [Franchisee] (Above Unit 3 (type: owner): Mark Harmon, Job at Above Unit 3: Head of Owner Office);
David Edwards [Corporate Officer] (Above Unit 4 (type: owner): Corporate, Job at Above Unit 4: Head of Owner Office);
Paul Cantu [District Agent] (Above Unit 5 (type: district): California, Job at Above Unit 5: Head of District);
Ray Lee [District Agent] (Above Unit 6 (type: district): Texas, Job at Above Unit 6: Head of District);
Cam Smith [Brand Officer] (Above Unit 7 (type: brand): Hot Potatoes, Job at Above Unit 5: Head of Brand); and
Angelos Levis[Brand Officer] (Above Unit 8 (type: brand): Big Burgers, Job at Above Unit 8: Head of Brand).

Following are examples of people and their associated associations/assignments for managerial jobs, in an embodiment of a nomenclature depicting same:
Jimmy [Sandwich Artist at Store 200] (Unit 2: Store 200, Job at Unit 2: Sandwich Artist);
Kevin [Cashier at Store 100] (Unit 1: Store 100, Job at Unit 1: Cashier);
Jim [Crew Member at Stores 100 and 200] (Unit 1: Store 100, Job at Unit 1: Crew Member, Unit 2: Store 200; Job at Unit 2: Crew Member);
Sabrina [Shift Leader at Store 300] (Unit 3: Store 300, Job at Unit 3: Shift Leader)

Implementation of organization element relationships in accordance with an embodiment of the present invention provides a number of useful functionalities. A key contributor to these useful functionalities is that this inventive organization element relationship management approach allows various managers and other key persons of an organization to have access to different administration functions based on their permissions. As discussed below in greater detail, examples of these useful functionalities include, but are not limited to, reporting, assigning courses, and editing users.

### Reporting

Through a suitable portion of a system configured in accordance with an embodiment of the present invention (e.g., a training platform portion of a computer implementing a method thereof (e.g., via software)), an authorized person (e.g., a manager) can have access to data of other persons in the same organization. This access is dependent upon permissions of the authorized person. In the example of a franchise organization, persons such as, for example, store managers, owners, multi-store franchisees, franchise agents, region managers, and the like need to have access to reporting data for purposes such as training performance and compliance. But, the data they are allowed to access reflects only employees of their stores. For example, a standalone system for learning management that is used across a plurality of franchise stores cannot be set up easily to address this need. The reason for this is that the stores are connected to different independent organization nodes (e.g. regions, franchisees, franchise agents etc) that cannot fit into a common pyramid-style hierarchy that such a standalone learning management system traditionally allows.

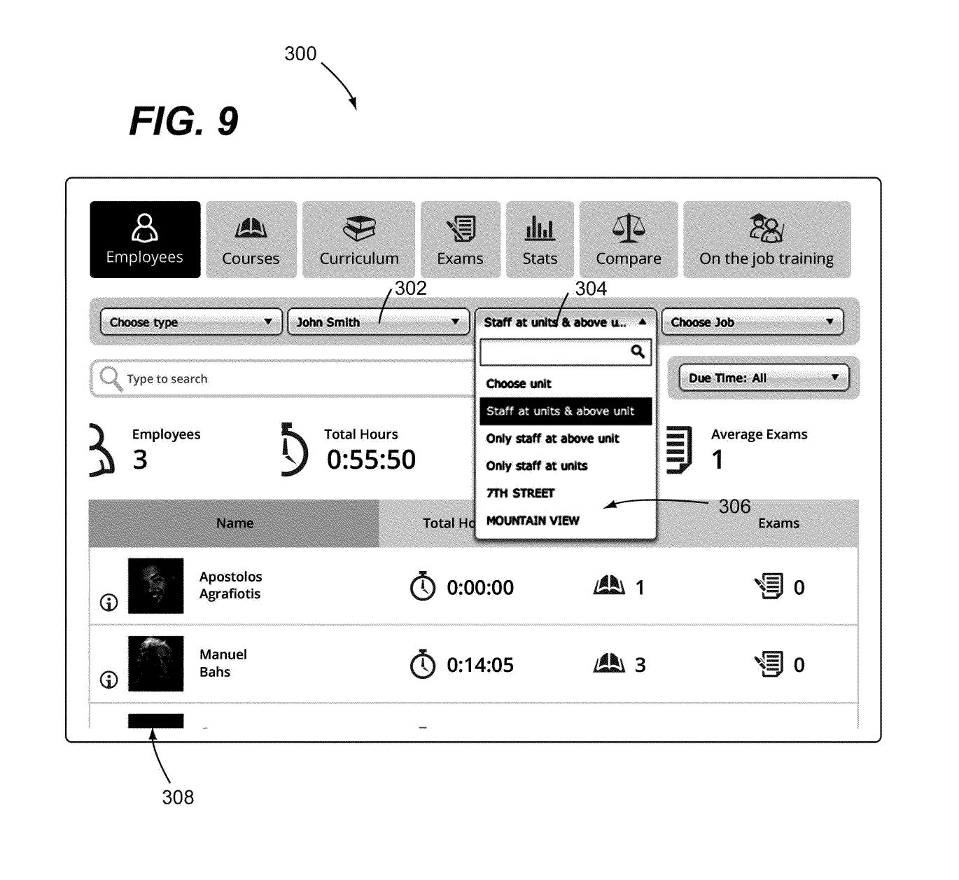

FIG. 9 shows a training platform portion 300 of a system configured in accordance with an embodiment of the present invention in which a franchisee (John Smith) who owns 2 stores of a franchise organization has reporting functionality for only his stores. The Above Unit filter 302 is locked therefore to “John Smith” and he can see from the Store filter 304 only his stores 306 and employees 308 that are connected to the stores 306. In a similar example, (not shown), a Region Manager of Texas for the same franchise organization will see only reporting data for stores that are in Texas and employees connected to those stores (i.e., the Above Unit filter is locked to “Texas”).

### Assigning Course

Through a suitable portion of a system configured in accordance with an embodiment of the present invention (e.g., a training platform portion thereof), an authorized person (e.g., a manager) can have access for assigning courses only to employees that are connected with his or her stores. In the example of a franchise organization, a corporate training manager is sometimes the only user that creates training courses for all employees across all stores. But, many organizations would like to give store owners, multi-store franchisees, region managers and other users the permission to create and assign training content only to employees of their stores to address special needs. Existing standalone learning management systems cannot address this need. In such existing standalone learning management systems, a content creator, training manager, or the like is a generic role that allows this user to create courses without restrictions on who will have access, to these and there is also no option to give a user the permission to assign courses only to employees of some stores.

In contrast, with a suitable portion of a system configured in accordance with an embodiment of the present invention (e.g., a training platform portion thereof), an authorized person (e.g., a franchisee) can have permission to create and assign courses only for his or her stores. At the same time, another user that could be at the same level with the franchisee (e.g. a region manager) could also be given the permission to create and assign courses for some of Franchisee A's stores as well as for some other stores that are owned by another franchisee. In the example of a franchise organization, a region manager of California will be able to see only his stores and employees when entering an Assign Course page of a suitable portion of a system configured in accordance with an embodiment of the present invention (e.g., a training platform portion thereof).

### Editing Users

Because franchise stores are generally owned by independent franchisees, employees of these stores are not in the HR system of the franchisor. Keeping their data up to date (e.g., the store(s) where they are working and job titles, etc) cannot be done easily or at all by the corporate administration. With a traditional franchise organization management solution, store managers or owners have to send regular updates to employee data to the franchisor. Taking into account the very high turnover in the industry of hourly workers, this can become very difficult and time consuming.

In contrast, through a suitable portion of a system configured in accordance with an embodiment of the present invention (e.g., a training platform portion thereof), an authorized person (e.g., owner of one or more franchise stores) can have access for enabling update of information about employees that are under his or her authorization (e.g., that are associated with stores that the authorized person manages or owns). In this respect, such an authorized person can be given the permission to administer the users of their stores directly without giving them access to all employees/stores. Advantageously, each one of them can have access only to employees that are under their authorization. In the example of a franchise organization, franchisee Bob Smith can be given the permission to edit users (e.g. edit jobs, stores etc) who are employees of his stores.

In view of the disclosures made herein, a skilled person will appreciate that implementing management of organization element relationships in accordance with an embodiment of the present invention supports mapping of organizational elements of complex organizational structure in a simplistic mariner. This is at least partially enabled by the uni-dimensional nature of the first-level entities (i.e., Units) and multi-dimensional nature of the second-level entities (i.e., Above Units). The manner in which embodiments of the present invention define and subsequently relate (i.e., relationships defined therebetween) Units, Above Units, Jobs, and People also contributes to mapping of organizational elements of complex organizational structure in a simplistic manner.

It is disclosed herein that an information management apparatus configured in accordance with an embodiment of the present invention can be implemented using any number of computer system platforms and architectures. In this regard, an information management apparatus configured in accordance with an embodiment of the present invention is not limited to being implemented in any particular computer system platform and architecture. For example, an organization element relationship management system configured in accordance with an embodiment of the present invention (i.e., an information management solution comprising software configured for implementing a suitably configured method) can be implemented as a server that communicates with other systems and devices (i.e., clients). Similarly, an organization element relationships management system configured in accordance with an embodiment of the present invention can be implemented as a standalone system (e.g., comprising all system elements) and that enables client devices to access information generated by the organization element relationships management system.

Turning now to a discussion of approaches for implementing embodiments of the present invention, systems and methods in accordance with embodiments of the present invention can be implemented in any number of different types of computer systems (i.e., a data processing systems) in addition to the specific physical implementation of a data processing system. Such a computer system can provide functionality as a result of logic hardwired or otherwise embodied in a circuit, which can operate in place of or together with software to execute one or more processes or one or more steps of one or more processes or methods described or illustrated herein. Reference to software in this disclosure can encompass logic, and reference to logic can encompass software. Moreover, reference to a computer-readable medium (also sometimes referred to as machine-readable medium” can encompass a circuit (such as an integrated circuit) storing software for execution, a circuit embodying logic for execution, or both, where appropriate. The present disclosure encompasses any suitable combination of hardware, software, or both. A specific implementation of such software implements a method for creating an organization structure chart configured in accordance with an embodiment of the present invention such as via a suitably configured user interface of a system (e.g., user interface 200) and/or a suitably configured portion of a system (e.g., the training platform portion 300).

The term “computer-readable medium” should be understood to include any structure that participates in providing data that can be read by an element of a computer system. Such a medium can take many forms, including but not limited to, non-volatile media, volatile media, and transmission media. Non-volatile media include, for example, optical or magnetic disks and other persistent memory. Volatile media include dynamic random access memory (DRAM) and/or static random access memory (SRAM). Transmission media include cables, wires, and fibers, including the wires that comprise a system bus coupled to processor. Common forms of machine-readable media include, for example, a floppy disk, a flexible disk, a hard disk, a magnetic tape, any other magnetic medium, a CD-ROM, a DVD, any other optical medium. The computer-readable medium has tangibly embodied thereon and accessible therefrom processor-executable instructions that, when executed by at least one data processing device of at least one computer, causes said at least one data processing device to perform a method comprising a plurality of operations of one or more method disclosed herein. In some embodiments, such computer-readable medium will be in the form of a non-transitory computer readable medium.

Those of skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments a computer system disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present invention.

The various illustrative logical blocks, modules, and circuits described in connection with a computer system as disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein (e.g., functionalities and/or capabilities thereof) can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

The previous description of the disclosed embodiments is provided to enable any person skilled in the art to make or use the present invention. Various modifications to these embodiments will be readily apparent to those skilled in the art, and the generic principles defined herein can be applied to other embodiments without departing from the spirit or scope of the invention. Thus, the present invention is not intended to be limited to the embodiments shown herein but is to be accorded the widest scope consistent with the principles and novel features disclosed herein.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

What is claimed is:

1. A method, comprising:
receiving, by at least one computer, information defining a plurality of first-level entities, wherein each one of the first-level entities defines a respective entity within a group of associated entities;
receiving, by the at least one computer, information defining a plurality of second-level entities, wherein each one of the second-level entities defines a respective entity within the group of associated entities;
receiving, by the at least one computer, information defining associations between the first and second level entities, wherein the associations indicate that each one of the first-level entities is directly associated with only one or more of the second-level entities and that each one of the second-level entities is directly associated with only one or more of the first-level entities; and
creating, by the at least one computer, a visual depiction of the entities and the association therebetween, wherein the associations between the first-level and second-level entities are depicted for indicating that each one of the first-level entities is directly associated with only one or more of the second-level entities and that each one of the second-level entities is directly associated with only one or more of the first-level entities.

2. The method of claim 1 wherein:
each one of the first-level entities is of an entity type that is the same as each other one of the first-level entities;
one or more of the second-level entities is of an entity type different than other ones of the second-level entities; and
the entity type of any one of the first-level entities is different than the entity type of any one of the second-level entities.

3. The method of claim 1 wherein:
creating the visual depiction of the entities and the association therebetween includes creating a two-level organization structure chart;
a first level of the two-level organization structure chart is uni-dimensional whereby all of the first-level entities are of a common entity type; and
a second level of the two-level organization structure chart is multi-dimensional whereby one or more of the second-level entities are of an entity type different than other ones of the second-level entities and whereby the entity type of any one of the first-level entities is different than the entity type of any one of the second-level entities.

4. The method of claim 1 wherein:
creating the visual depiction of the entities and the association therebetween includes creating a two-level organization structure chart;
each one of the first-level entities is represented by a respective icon located exclusively within a first level of the two-level organization structure chart;
each one of the second-level entities is represented by a respective icon located exclusively within a second level of the two-level organization structure chart; and
the associations between each one of the first-level entities and an associated one of the second-level entities is represented by a connection between the respective icons thereof.

5. The method of claim 4 wherein:
each one of the first-level entities is of an entity type that is the same as each other one of the first-level entities;
each one of the second-level entities is of an entity type selected from a plurality of different entity types; and
the entity type of any one of the first-level entities is different than the entity type of any one of the second-level entities.

6. The method of claim 1 wherein:
the group of associated entities is an organization having a franchise structure;
each one of the first-level entities is one of a plurality of stores affiliated with the organization; and
each one of the second-level entities is one of a franchisee associated with one or more of the stores, a franchisee agent associated with one or more of the stores, a region in which one or more of the stores is located, and a brand associated with a particular one of the stores.

7. The method of claim 6 wherein:
creating the visual depiction of the entities and the association therebetween includes creating a two-level organization structure chart;
each one of the first-level entities is represented by a respective icon located exclusively within a first level of the two-level organization structure chart;
each one of the second-level entities is represented by a respective icon located exclusively within a second level of the two-level organization structure chart; and
the associations between each one of the first-level entities and an associated one of the second-level entities is represented by a connection between the respective icons thereof.

8. A non-transitory computer-readable storage medium having tangibly embodied thereon and accessible therefrom instructions interpretable by at least one data processing device, the instructions are configured for causing the at least one data processing device to perform a method enabling a user to create an organization structure chart for depicting relationships between entities of an organization, the method comprising:
specifying a plurality of organizational elements that are all affiliated with the organization;
assigning a first plurality of the organizational elements to a first level of an organization structure chart characterizing relationships between the organizational elements;
assigning a second plurality of the organizational elements to a second level of the organization structure chart; and
indicating relationships between the organizational elements of the first level of the organization structure chart and the organizational elements of the second level of the organization structure chart, wherein indicating the relationships is limited to indicating that each one of the organizational elements of a particular one of the levels is associated with one or more of the organizational elements of the other one of the levels.

9. The non-transitory computer-readable storage medium of claim 8 wherein:
each one of the organizational elements assigned to the first level of the organization structure chart is of an entity type that is the same as each other one of the organizational elements assigned to the first level of the organization structure chart;
one or more of the organizational elements assigned to the second level of the organization structure chart is of an entity type different than other ones of the organizational elements assigned to the second level of the organization structure chart; and
the entity type of any one of the organizational elements assigned to the first level of the organization structure chart is different than the entity type of any one of the organizational elements assigned to the second level of the organization structure chart.

10. The non-transitory computer-readable storage medium of claim 8 wherein indicating the relationships between the organizational elements of the first level of the organization structure chart and the organizational elements of the second level of the organization structure chart includes:
depicting each one of the organizational elements assigned to the first level of the organization structure chart by a respective icon located exclusively within the first level of the organization structure chart;
depicting each one of the organizational elements assigned to the second level of the organization structure chart by a respective icon located exclusively within the second level of the organization structure chart; and
depicting the associations between each one of the first-level organizational elements and an associated one of the second-level organizational elements as a connection between the respective icons thereof.

11. The non-transitory computer-readable storage medium of claim 10 wherein:
each one of the organizational elements assigned to the first level of the organization structure chart is of an entity type that is the same as each other one of the first-level organizational elements;
one or more of the organizational elements assigned to the second level of the organization structure chart is of an entity type selected from a plurality of different entity types; and
the entity type of any one of the organizational elements assigned to the first level of the organization structure chart is different than the entity type of any one of the organizational elements assigned to the second level of the organization structure chart.

12. The non-transitory computer-readable storage medium of claim 8 wherein:
the organization has a franchise structure;
each one of the first-level organizational elements is one of a plurality of places of business of the organization; and
each one of the second-level organizational elements is one of a franchisee associated with one or more of the places of business, a franchisee agent associated with one or more of the places of business, a region in which one or more of the places of business is located, and a brand associated with a particular one of the places of business.

13. The non-transitory computer-readable storage medium of claim 12 wherein:
creating the visual depiction of the organizational elements and the association therebetween includes creating a two-level organization structure chart;
each one of the first-level organizational elements is represented by a respective icon located exclusively within a first level of the two-level organization structure chart;
each one of the second-level organizational elements is represented by a respective icon located exclusively within a second level of the two-level organization structure chart; and
associations between each one of the first-level organizational elements and an associated one of the second-level organizational elements is represented by a connection between the respective icons thereof.

14. A non-transitory computer-readable storage medium having tangibly embodied thereon and accessible therefrom instructions interpretable by at least one data processing device, the instructions are configured for causing the at least one data processing device to perform a method enabling a user to create a two-level organization structure chart that depicts associations between a plurality of entities, the method comprising:
instantiating a plurality of first-level entities each defining a respective entity from a collection of entities;
instantiating a plurality of second-level entities each defining a respective entity from the collection of entities; and
defining associations between the first-level and second-level entities in a manner such that each one of the first-level entities is directly associated with only one or more of the second-level entities and such that each one of the second-level entities is directly associated with only one or more of the first-level entities.

15. The non-transitory computer-readable storage medium of claim 14 wherein:
each one of the first-level entities is of an entity type that is the same as each other one of the first-level entities;
one or more of the second-level entities is of an entity type different than other ones of the second-level entities; and
the entity type of any one of the first-level entities is different than the entity type of any one of the second-level entities.

16. The non-transitory computer-readable storage medium of claim 14 wherein:
defining the associations between the first-level and second-level entities includes creating a two-level organization structure chart;
a first level of the two-level organization structure chart is uni-dimensional whereby all of the first-level entities are of a common entity type; and
a second level of the two-level organization structure chart is multi-dimensional whereby one or more of the second-level entities are of an entity type different than other ones of the second-level entities and whereby the entity type of any one of the first-level entities is different than the entity type of any one of the second-level entities.

17. The non-transitory computer-readable storage medium of claim 14 wherein:
defining the associations between the first-level and second-level entities includes creating a two-level organization structure chart;
each one of the first-level entities is represented by a respective icon located exclusively within a first level of the two-level organization structure chart;
each one of the second-level entities is represented by a respective icon located exclusively within a second level of the two-level organization structure chart; and
the associations between each one of the first-level entities and an associated one of the second-level entities is represented by a connection between the respective icons thereof.

18. The non-transitory computer-readable storage medium of claim 17 wherein:
each one of the first-level entities is of an entity type that is the same as each other one of the first-level entities;
each one of the second-level entities is of an entity type selected from a plurality of different entity types; and
the entity type of any one of the first-level entities is different than the entity type of any one of the second-level entities.

19. The non-transitory computer-readable storage medium of claim 14 wherein:
the group of associated entities is an organization having a franchise structure;
each one of the first-level entities is one of a plurality of stores affiliated with the organization; and
each one of the second-level entities is one of a franchisee associated with one or more of the stores, a franchisee agent associated with one or more of the stores, a region in which one or more of the stores is located, and a brand associated with a particular one of the stores.

20. The non-transitory computer-readable storage medium of claim 19 wherein:
defining the associations between the first-level and second-level entities includes creating a two-level organization structure chart;
each one of the first-level entities is represented by a respective icon located exclusively within a first level of the two-level organization structure chart;
each one of the second-level entities is represented by a respective icon located exclusively within a second level of the two-level organization structure chart; and
the associations between each one of the first-level entities and an associated one of the second-level entities is represented by a connection between the respective icons thereof.
